(19) United States
(12) Patent Application Publication
(10) Pub. No.: US 2012/0047504 A1
(43) Pub. Date: Feb. 23, 2012

(54) METHODS, SYSTEMS, AND COMPUTER PROGRAM PRODUCTS FOR MAINTAINING A RESOURCE BASED ON A COST OF ENERGY

(76) Inventor: Robert Paul Morris, Raleigh, NC (US)

(21) Appl. No.: 12/857,836

(22) Filed: Aug. 17, 2010

(51) Int. Cl. G06F 9/46

(52) U.S. Cl. 718/100

(57) ABSTRACT

Methods and systems are described for maintaining a resource based on a cost of energy. In one aspect, a first energy cost, for accessing a resource via an energy consuming component in an execution environment, is detected. The first energy cost is measured according to a specified metric. A determination is made that a configured maintenance condition is met based on the energy cost. A maintenance operation is identified for configuring at least one of the resource and the energy consuming component for accessing the resource at a second energy cost that is less than the first energy cost. An indication to start the maintenance operation is sent in response to determining that the maintenance condition is met.

### RELATED APPLICATIONS

This application is related to the following commonly owned U.S. patent applications, the entire disclosure of each being incorporated by reference herein: application Ser. No. ______, (Docket No. 0137) filed on Aug. 17, 2010, entitled “Methods, Systems, and Program Products for Selecting a Resource in Response to a Change in Available Energy”;

Application Ser. No. ______, (Docket No. 0162) filed on Aug. 17, 2010, entitled “Methods, Systems, and Program Products for Selecting a Resource Based on a Measure of a Processing Cost”; and

Application Ser. No. ______, (Docket No. 0125) filed on Aug. 17, 2010, entitled “Methods, Systems, and Program Products for Presenting an Indication of a Cost of Processing a Resource”.

### BACKGROUND

Maintenance operations such as resizing of memory swap files, defragmentation of disks, cleaning caches, and deleting temporary files are performed to optimize the speed of a particular component of an electronic device. However, maintenance operations have respective energy costs. Maintenance operations are currently performed without regard to these energy costs. For example, many defragmenting programs run at set times whether defragmentation is needed or not. In other cases, a defragmentation operation may be initiated when fragmentation reaches a specified threshold for a storage device. Whether the benefit is worth the energy cost is not a consideration.

Accordingly, there exists a need for methods, systems, and computer program products for maintaining a resource based on a cost of energy.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for maintaining a resource based on a cost of energy. In one aspect, the method includes detecting a first energy cost, measured according to a specified metric, for accessing a resource via an energy consuming component in an execution environment. The method further includes determining that a configured maintenance condition is met based on the energy cost. The method still further includes identifying a maintenance operation for configuring at least one of the resource and the energy consuming component for accessing the resource at a second energy cost that is less than the first energy cost. The method also includes, in response to determining that the maintenance condition is met, sending an indication to start the maintenance operation.

Further, a system for maintaining a resource based on a cost of energy is described. The system includes a cost monitor component, a maintenance test component, a maintenance link component, and a maintenance operations component adapted for operation in an execution environment. The system includes the cost monitor component configured for detecting a first energy cost, measured according to a specified metric, for accessing a resource via an energy consuming component in an execution environment. The system further includes the maintenance test component configured. for determining that a configured maintenance condition is met based on the energy cost. The system still further includes the maintenance link component configured for identifying a maintenance operation for configuring at least one of the resource and the energy consuming component for accessing the resource at a second energy cost that is less than the first energy cost. The system also includes the maintenance operations component configured for, in response to determining that the maintenance condition is met, sending an indication to start the maintenance operation.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for maintaining a resource based on a cost of energy according to an aspect of the subject matter described herein;

FIG. 3 is a block diagram illustrating an arrangement of components for maintaining a resource based on a cost of energy according to another aspect of the subject matter described herein;

FIG. 4 is a block diagram illustrating an arrangement of components for maintaining a resource based on a cost of energy according to another aspect of the subject matter described herein;

FIG. 5 is a block diagram illustrating an arrangement of components for maintaining a resource based on a cost of energy according to another aspect of the subject matter described herein; and

FIG. 6 is a network diagram illustrating an exemplary system for maintaining a resource based on a cost of energy according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

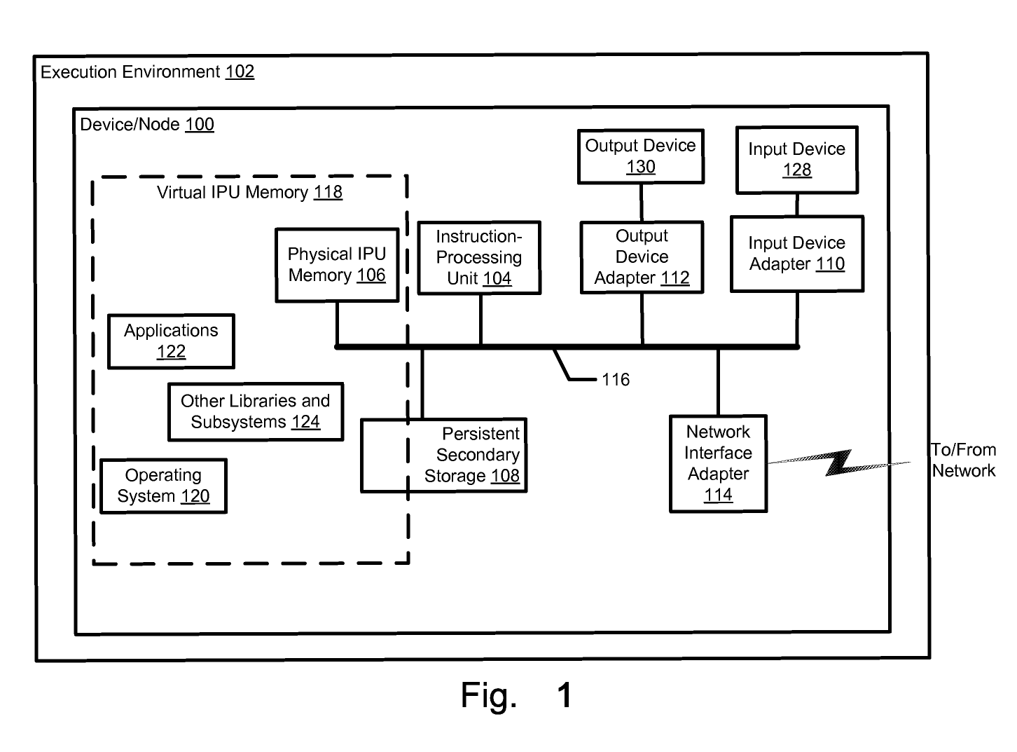

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage 108 may include removable media. The drives and their associated computer readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein respectively refer to one or more devices and nodes providing and/or otherwise included in an execution environment unless clearly indicated otherwise.

The components of a user interface are generically referred to herein as “user interface elements”. More specifically, visual components of a user interface are referred to herein as “visual interface elements”. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as “audio interface elements”, tactile output components referred to as “tactile interface elements”, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable. The user detectable representation is presented based on the sent information. The sent information is referred to herein as “presentation information”. Presentation information may include data in one or more formats. Exemplary formats include image formats such as JPEG, video formats such as MP4, audio formats, markup language data such as HTML and other XML-based markup, and/or instructions such as those defined by various script languages, byte code, and/or machine code. For example, a web page received by a browser from a remote application provider may include HTML ECMAScript, and/or byte code for presenting one or more user interface elements included in a user interface of the remote application. Components configured to send information representing one or more program entities for presenting particular types of output by particular types of output devices include visual interface elements, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter, and/or a storage medium of an output device. A screen of a display, for example, is a presentation space.

As used herein, the terms “program” and “executable” refer to any data representation that may be translated into a set of machine code instructions and optionally associated program data. Thus, a program component and/or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or analogous tool.

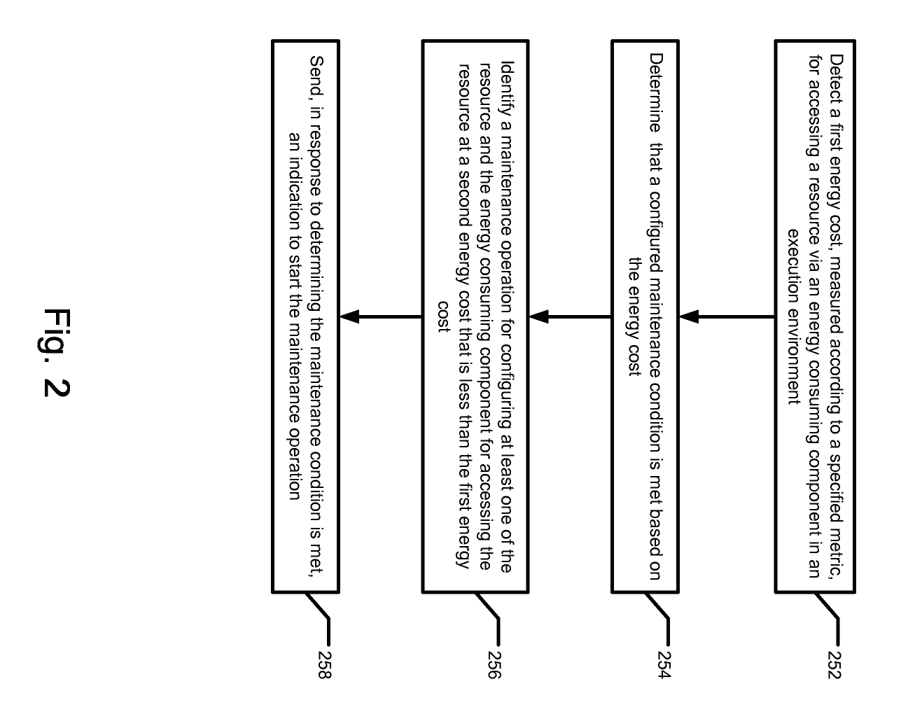

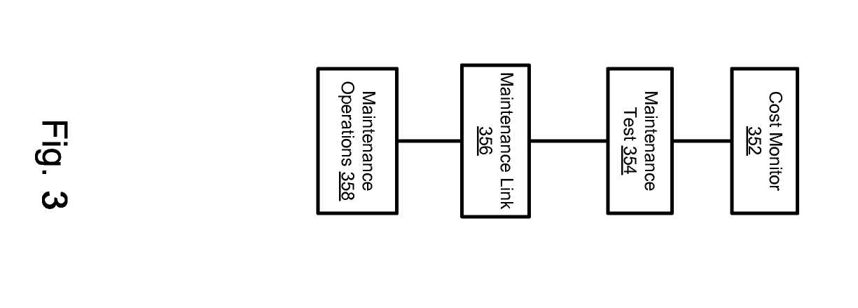

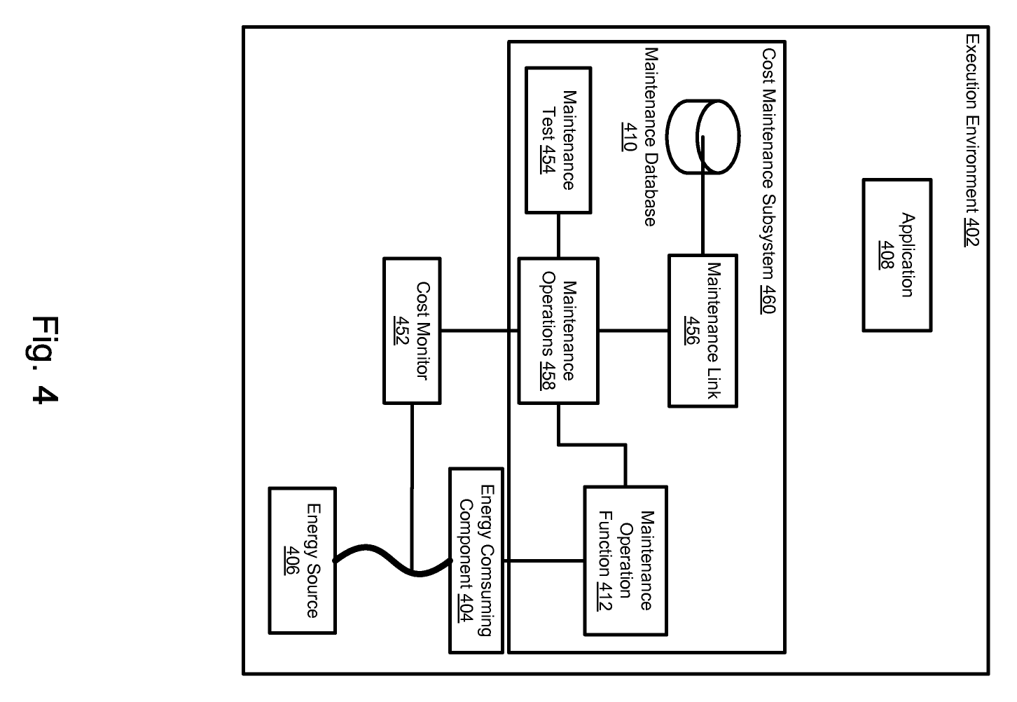

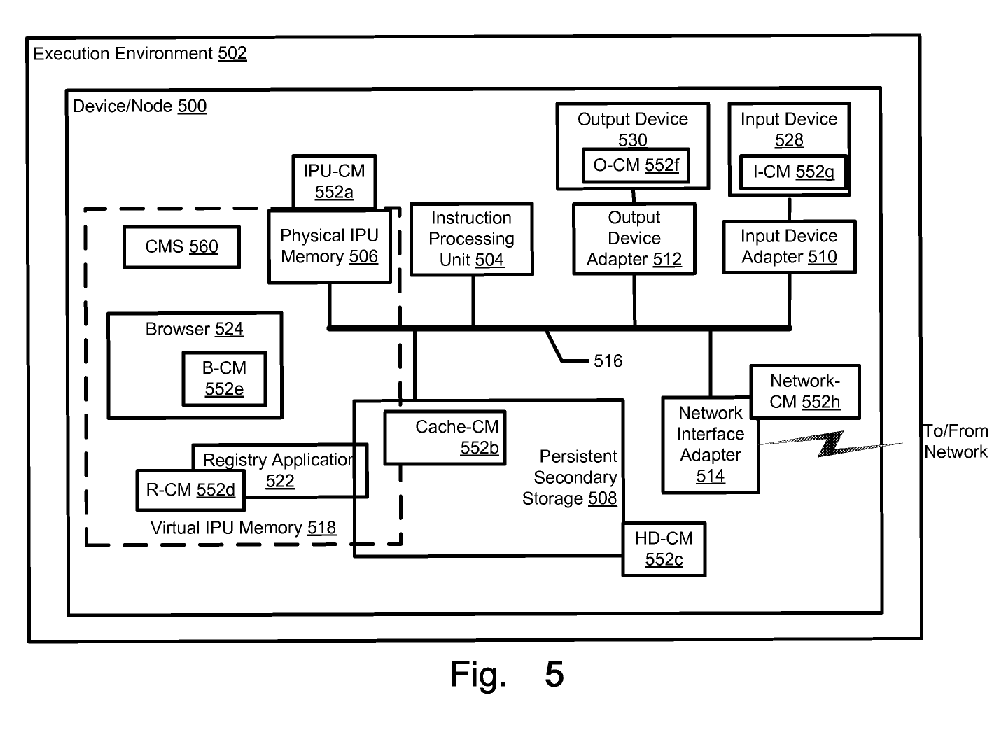

The block diagram in FIG. 3 illustrates an exemplary system for maintaining a resource based on a cost of energy according to the method illustrated in FIG. 2. FIG. 3 illustrates a system, adapted for operation in an execution environment, such as execution environment 102 in FIG. 1, for performing the method illustrated in FIG. 2. The system illustrated includes a cost monitor component 352, a maintenance test component 354, a maintenance link component 356, and a maintenance operations component 358. The execution environment includes an instruction-processing unit, such as IPU 104, for processing an instruction in at least one of the cost monitor component 352, the maintenance test component 354, the maintenance link component 356, and the maintenance operations component 358. The components illustrated in FIG. 3 may be adapted for performing the method illustrated in FIG. 2 in a number of execution environments. Adaptations of the components illustrated in FIG. 3 for performing the method illustrated in FIG. 2 are described operating in execution environment 402 illustrated in FIG. 4 and also in execution environment 502 illustrated in FIG. 5.

FIG. 1 illustrates key components of an exemplary device that may at least partially provide and/or otherwise be included in an execution environment, such as those illustrated in FIG. 4 and FIG. 5. The components illustrated in FIG. 3 and/or FIG. 4 may be included in and/or otherwise adapted to operate with the components of FIG. 1 to create a variety of arrangements of components according to the subject matter described herein. FIG. 5 illustrates an example of such a combination.

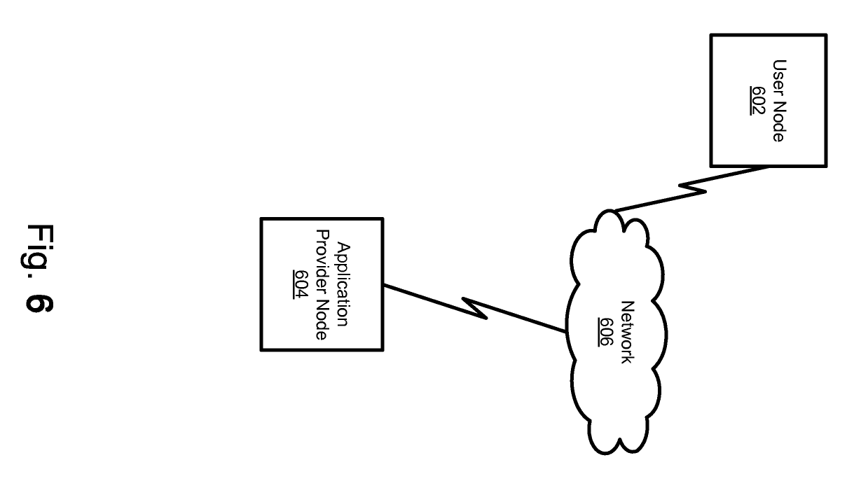

FIG. 4 illustrates execution environment 402 hosting cost maintenance subsystem 460 including an adaptation of the arrangement of components in FIG. 3. An instance of execution environment 402 may include and/or may be provided by an end-user device illustrated by user node 602 in FIG. 6. Alternatively or additionally, another instance of execution environment 402 may include and/or may be provided by a server device illustrated by application provider node 604 in FIG. 6. FIG. 6 illustrates user node 602 and application provider node 604 operatively coupled to network 606. In another aspect, execution environment 402 may include and/or otherwise be provided by a device not coupled to a network.

Some or all of the components in the arrangement illustrated in FIG. 3 may be installed persistently in an execution environment and/or some or all may be retrieved as needed via a network from another execution environment. For example, an application 408 operating in user node 602 may include a web browser. The web browser may retrieve a web client or network application agent that includes some or all of an adaptation of the arrangement in FIG. 3. The web client may be received via network communication between the browser and a network application. One or more components of cost maintenance subsystem 460 in FIG. 4 may be received from a remote application provider via a network. User node 602 illustrates a node included in and/or otherwise providing an execution environment 402. Application provider node 604 illustrates a node hosting a network application configured to provide some or all of the components for a cost maintenance subsystem 460 to user node 602 via network 606. User node 602 may be included in and/or otherwise provide at least part of an execution environment for components and content received from a network application in application provider node 604.

FIG. 5 illustrates execution environment 502 including adaptations and/or analogs of components in execution environment 102 in FIG. 1 and described above. Execution environment 502 includes an adaptation and/or analog of a cost maintenance subsystem illustrated as cost maintenance subsystem (CMS) 560. CMS 560 includes at least a portion of another adaptation or analog of the arrangement of components in FIG. 3 with the remainder adapted for operation in execution environment 502 external to CMS 560. An execution environment 502 may include and/or otherwise operate in an end-user device, such as user node 602 in FIG. 6. An execution environment 502 may include and/or otherwise operate in a server device, such as application provider node 604.

The various adaptations described herein of the arrangement in FIG. 3 are not exhaustive. For example, those skilled in the art will see based on the description herein that arrangements of components for performing the method illustrated in FIG. 2 may be distributed across more than one node and/or execution environment. For example, such an arrangement may operate at least partially in a user node 602 and at least partially in an execution environment included in and/or including application provider node 604.

With reference to FIG. 2, block 252 illustrates that the method includes detecting a first energy cost, measured according to a specified metric, for accessing a resource via an energy consuming component in an execution environment. Accordingly, a system for maintaining a resource based on a cost of energy includes means for detecting a first energy cost, measured according to a specified metric, for accessing a resource via an energy consuming component in an execution environment. For example, as illustrated in FIG. 3, the cost monitor component 352 is configured for detecting a first energy cost, measured according to a specified metric, for accessing a resource via an energy consuming component in an execution environment. FIG. 4 illustrate cost monitor component 452 as an adaptation of and/or analog of cost monitor component 352 in FIG. 3. One or more cost monitor components 452 operate in execution environment 402. FIG. 5 illustrates cost monitor components 552 as adaptations and/or analogs of cost monitor component 352 in FIG. 3. FIG. 5 illustrates several cost monitor components 552 operating in execution environment 502.

A metric defines a unit of measure. For example, an “inch” is a unit of measure for measuring length. A “kilowatt-hour” (kWh) is a unit of measurement in a metric for measuring an amount of energy. Instead of or in addition to measuring an amount a metric may measure a rate. “Kilowatts per hour” (kWh/h) is energy or power metric for measuring a rate of energy used. A “measure” is a result of a particular measuring or measurement process. For example, 3 inches is a measure according to the length metric for inches, and 1000 kWh is a measure of an energy metric identifying an amount of energy. As used herein, a “measure of a processing cost” refers to a result of a measuring process for determining a processing cost according to a specified metric. Measuring may include estimating a measurement. A used herein, a “measure of energy”, also referred as an “energy cost”, is a result of a measuring and/or estimating process, based on a metric, for determining a measure of energy associated with accessing a resource. The phrases “energy cost”, “energy access cost”, and “access cost” are used interchangeably herein.

An access cost may be determined and/or expressed according to any metric, directly and/or indirectly, providing an indication of cost of energy associated with accessing a resource via an energy consuming component, such as an electronic component, in an execution environment. A metric for determining an energy cost in terms of electrical power may be determined by monitoring a rate of electrical energy utilized over time period by a hardware component that is included in accessing a resource. For example, a flow of electricity to a network interface adapter may be monitored, for resources where processing the resources includes sending and/or receiving data via a network. Some of the data may be included in the resources. The metric may represent the cost, for example, in kilowatt-hours, in kilowatts per hour, in transmission time, in bandwidth utilization, in latency, and/or in monetary units. In FIG. 4. cost monitor component 452 may be invoked to determine and/or otherwise identify a measure of an energy cost for accessing a particular resource in performing an operation.

FIG. 4 illustrates cost monitor component 452 coupled directly and/or indirectly to an electrical circuit for providing electronic energy consuming component 404 with electricity from energy source 406. Exemplary energy sources include a battery, a transformer, and/or a plug-in outlet to a power grid. Cost monitor component 452 in various aspects may determine an access cost according to one or more specified metrics. For example, cost monitor component 452 may determine a cost based on a metric for measuring energy transferred from energy source 406 to electronic energy consuming component 404 over a period of time. Cost monitor component 452 may measure the energy transferred according to a metric for kilowatts per hour (kWh/h) and/or may determine a cost based on a metric for measuring a monetary cost based on the measured kWh/h. One or more monetary cost rates may be received from and/or otherwise provided by maintenance operations component 458.

Rate information may be configured by a user of a node including and/or included in execution environment 402. Rate information may be accessed from one or more accessible data storage media, and/or may be received via network 606 from another node. For example, real-time rate information may be received from an organization that generates and/or distributes electrical power.

In another aspect, cost monitor component 452 may detect information for determining an access cost for a single access and/or may detect multiple costs over a time period. For example, cost monitor component 452 may determine a count of instances and/or one or more durations of time in which a voltage level and/or amperage level meets a specified threshold condition. The determined information may be a measure of power quality and/or energy efficiency of one or both of energy consuming component 404 and energy source 406. An energy cost may be measured based on power quality and/or energy efficiency.

FIG. 5 illustrates a plurality of cost monitor (CM) components included in execution environment 502. Execution environment 502 is illustrated as an adaptation of execution environment 102 described above. Execution environment 502 includes IPU cost monitor component (IPU-CM) 552a for determining and/or otherwise detecting a measure of energy for accessing a resource via IPU 504. Exemplary resources accessible via IPU 504 include a machine code instruction and a data item for processing by one or more machine code instructions. A resource may be further identified by a type of addressable entity the resource includes and/or is included in. A resource may be identified by a task performed by one or more machine code instructions such as loading and/or unloading a portion of virtual IPU memory 518 from physical IPU memory 506. An access with respect to IPU 504 may be defined to include a read of a processor memory location, a write to a processor memory location, and/or a processing of an instruction loaded into IPU 504. Various types of accesses may be defined more particularly by distinguishing accesses that include processor cache hits and/or misses, page table hits and/or misses, and/or context switches. Detecting a cost may include determining and/or otherwise identifying a statistical measure of energy based on a number of accesses of one or more types of resources.

FIG. 5 also illustrates cache cost monitor (cache-CM) component 552b for detecting an energy cost for accessing a resource included in a cache. Exemplary caches include an IPU cache, a data base cache, a file system cache, and/or a browser cache. As with IPU 504, an access is defined in terms of operations performed by the cache and a resource is defined in terms of data and/or services accessible via the cache. One or more measures of energy cost may be determined for accessing a cache and/or for accessing a resource via a cache.

FIG. 5 additionally illustrates hard drive cost monitor (HD-CM) component 552c for detecting an energy cost for accessing a data entity and/or service via a hard-drive component (not shown) providing at least a portion of persistent secondary storage 508. Other types of data storage devices supporting persistent data storage media may be monitored in other aspects and adaptations of cost monitor component 352 in FIG. 3. As with an IPU and a cache, an access, of a resource via a data storage device such as a hard drive, may be defined based on one or more operations performed by the data storage device and/or may be defined based on one or more operations performed by components interoperating with the data storage device. A resource may be defined in terms of data and/or services accessible via the data storage device. One or more measures of energy may be determined for an access to a resource included in and/or otherwise accessible via a data storage device.

FIG. 5 further illustrates registry cost monitor (R-CM) component 552d for detecting an energy cost for accessing a resource included in a registry such as an operating system registry for storing configuration data and/or a lightweight directory access protocol (LDAP) registry for storing various types of information including address book entries, digital certificates, and/or user identifiers. Other exemplary registries include domain name system (DNS) databases and universal description discovery and integration (UDDI) registries. Again, an access is defined in terms of operations performed by the registry and/or in terms of operations performed by components interoperating with the registry. Resources may be defined in terms of data and/or services accessible via a registry. One or more measures of an energy cost may be determined.

FIG. 5 further illustrates browser cost monitor component (B-CM) 552e for detecting an energy cost for accessing a resource via a browser. A browser may access resources via a variety of energy consuming components in an execution environment hosting the browser as well as resources accessible via components in nodes in other execution environments. B-CM 552e may interoperate with other cost monitor component(s) 552 directly and/or indirectly in detecting an access cost for a resource.

A cost monitor component may be provided for an output component such as a display device, an input component such as a keyboard, and/or a network component such as a network interface component. FIG. 5 illustrates output cost monitor (O-CM) component 552f, input cost monitor (I-CM) component 552g, and network cost monitor (network-CM) component 552h.

Exemplary metrics for measuring an energy access cost include metrics for power, monetary metrics, time metrics, kinetic or stored energy metrics, heat metrics, resistance metrics based on mechanical and/or electrical resistance, metrics for measuring various energy and/or power consuming activities and/or operations, light metrics, movement metrics, mass metrics, and weight metrics.

A particular metric for determining an energy access cost for a resource may be selected and/or otherwise identified based on one or more attributes of a resource, an operation that includes accessing the resource, a program component for performing some or all of the operation, a hardware component included in accessing the resource, a user, an organization, and/or a task, to name a few examples. For example, an access cost may be measured by counting occurrences of an energy consuming activity, such as disk read operations.

A metric such as a count of machine code instructions executed by an IPU may be specified and/or determined in accessing a resource. An IPU based metric may be selected for measuring a cost for accessing a resource stored in a physical processor memory. In another aspect, an application or process may access a resource in a display device to present a user interface to a user. A metric for measuring heat and/or light generated by the display device in accessing the resource may be specified. The display device resource may include a data storage component, a screen, and/or a light emitting component.

Cost monitor component 452, in an aspect, may determine and/or otherwise may detect an energy access cost based on metadata provided in and/or with one or more of a resource, a program component for performing an operation that includes accessing the resource, and a hardware component included in accessing the resource. An energy access cost may be predetermined and located by cost monitor component 452 in and/or associated with a resource, a program component, and/or a hardware component. Cost monitor component 452 may access a table and/or other structure including predefined values for measures of energy access costs according to one or more metrics such as a temperature based metric for measuring a change in temperature of a hardware component and/or for measures of a time based access costs represented in US dollars.

Cost monitor component 452 may look up and/or may otherwise identify a predefined value for a resource based on a type of the resource, a size of the resource, a power source, a hardware component, and/or a program component for accessing the resource. The predefined value may be an energy access cost and/or may be an input for determining an energy access cost expressed according to an identified metric. For example, a predefined value may be multiplied by a measure of time that a resource is accessed, via an energy consuming component, by a program component to produce a time based metric such as kilowatt-hours or disk reads per minute.

In another aspect, cost monitor component 452 may determine an energy access cost by calculating a measure of cost according to the specified metric and/or may interoperate with a sensor, such as a thermometer, in measuring a cost of accessing a resource. Cost monitor component 452 may include and/or otherwise access one or more measurement components for determining an access cost according to one or more metrics.

In another aspect, a cost monitor component may operate in an application 408. The cost monitor component may determine an energy access cost for resources accessed by the application 408. The application 408 is a program component and may include one or more program components. The resources may include resources provided by the application 408 to other applications, subsystems, and/or components operating in execution environment 402 and/or in another execution environment included in and/or otherwise provided by one or more devices. For example, an application 408 may process an image and/or a video to present as a desktop background.

Cost monitor component 452 may determine an energy access cost for accessing a resource included in a display device to present the image and/or the video via the display. For example, cost monitor component 452 may be configured with and/or otherwise may determine a measure based on a count of display refreshes over a specified period of time to determine an energy access cost for accessing a resource in the display to present the image and/or the video.

One or more resources, accessible to an application 408 operating in execution environment 402 in a node, may include data stored by another node. Cost monitor component 452 may determine an energy access cost for transmitting a request for receiving the data and/or for receiving some or all of the data in a message from the other node via a network adapter in the execution environment hosting the application. For example, a cost monitor component 452 may be configured with and/or otherwise may determine a measure based on a count of bytes in a resource and/or in an encoded translation of the resource for transmitting.

In another aspect, a cost monitor component 452 may operate in a network application agent such as a web page and/or script in a browser. A network application agent may be received by a browser included in application 408 operating in user node 602 in FIG. 6. The network application agent may be received by user node 602 from a network application operating in application provider node 604. A cost monitor component 452 and/or an analog may operate in application provider node 604 operating in the network application, such as a web service. Alternatively or additionally another cost monitor component 452 may operate in the network application agent in the browser in user node 602. One or both of the cost monitor components 452 may separately or cooperatively determine an energy access cost for a resource accessed by the network application and/or the network application agent. One or both of the cost monitor components 452 may be components in a cost monitor system distributed between the network application agent and the network application. Resources may include resources provided by the network application agent to the browser and/or extensions of the browser. The resources may further include resources provided to other nodes in network 606 by the network application agent and/or the network application.

One or both of a cost monitor component operating in user node 602 and a cost monitor component operating in application provider node 604 may determine an energy access cost for accessing one or more resources accessed via network 606 in FIG. 6. Transmitting resource data may include encoding, decoding, filtering, translating, and/or transforming some or all of the data in a resource. One or more energy consuming components may be included in accessing the resource. For example, a resource may be compressed prior to transmitting via network 606. The cost monitor component operating in the browser may be configured to determine a metric based on a type of physical layer network included in network 606; based on an encoding, decoding, and/or other transformation; based on a manufacturer and/or type of network interface component; and/or based on network throughput data and/or on other network attributes and/or metadata. The measure may be an access cost for transmitting a web document via a network via a modem, an access cost for retrieving image data in the document from a hard drive, an access cost for decoding data received via network 606, and/or an access cost for transmitting data over a secure network connection. One or both cost monitor components may be configured with and/or otherwise configured to identify a predefined energy access cost according to a metric selected by a developer of the browser and/or the network application.

In FIG. 4, cost monitor component 452 is illustrated interoperating with cost maintenance subsystem 460 in execution environment 402. Cost maintenance subsystem 460 may be a subsystem of execution environment 402 that provides services to a number of program components in execution environment 402 and/or in other execution environment(s) communicatively coupled via network 606 in FIG. 6. Cost monitor component 452 may determine an energy access cost(s) for various resources accessed by various applications 408 operating in execution environment 402. The resources may include resources provided to and/or otherwise accessible to applications 408 via various subsystems of execution environment 402, such as a file system (not shown) and/or network stack (not shown).

One or more resources accessed by application 408 may include documents having various content types. Cost monitor component 452 may determine an energy access cost for the documents expressed by a metric based on formats of the respective documents identified by content type identifiers and/or based on an operation for accessing the documents. The operation may be performed by application 408 and/or may be performed by one or more other components.

In FIG. 4, cost maintenance subsystem 460 may determine energy access costs for resources, freeing applications 408 from performing this operation. Note that in an aspect at least some of cost maintenance subsystem 460 may operate in a remote node.

Returning to FIG. 2, block 254 illustrates the method further includes determining that a configured maintenance condition is met based on the energy cost. Accordingly, a system for maintaining a resource based on a cost of energy includes means for determining that a configured maintenance condition is met based on the energy cost. For example, as illustrated in FIG. 3 the maintenance test component 354 is configured for determining that a configured maintenance condition is met based on the energy cost. FIG. 4 illustrates maintenance test component 454 as an adaptation and/or analog of maintenance test component 354 in FIG. 3. One or more maintenance test components 454 operate in execution environment 402. FIG. 5 illustrates cost maintenance subsystem (CMS) 560 including a maintenance test component (not shown) as an adaptation of and/or analog of maintenance test component 354 in FIG. 3. One or more maintenance test components operate in execution environment 502.

In FIG. 4 cost monitor component 452 may interoperate with maintenance test component 454 to communicate one or more detected access cost(s) for one or more resources. Interoperation may be direct. For example, maintenance test component 454 may request an access cost periodically and/or as instructed, for example, by maintenance operations component 458. Alternatively or additionally, interoperation may be indirect, for example via maintenance operations component 458 as illustrated in FIG. 4.

In an aspect, maintenance operations component 458 may include and/or otherwise may access a configured maintenance condition for energy consuming component 404. The maintenance condition may be accessed from and/or via energy consuming component 404. In another aspect, maintenance test component 454 may include and/or otherwise access a maintenance condition for energy consuming component 404.

Maintenance test component 454 may evaluate a maintenance condition based on one or more access cost(s) measured and/or otherwise determined. A maintenance condition may be evaluated according to a predetermined time schedule, when instructed by maintenance operations component 458, and/or in response to an event such as a detected error and/or a detected user input. The maintenance condition may be specified declaratively and/or in one or more executable instructions. The maintenance condition may include testing a threshold, a range, and/or a matching criterion.

FIG. 5 includes one or more maintenance test components (not shown) in CMS 560. Alternatively or additionally, one more or maintenance test components may be distributed within execution environment 502 and/or may operate in another node accessible via network 604. A maintenance test component may provide general purpose testing of any of a number of maintenance conditions configured for any of a number of resources. A maintenance test component may be subsystem, component, resource, and/or access type specific.

Returning to FIG. 2, block 256 illustrates that the method yet further includes identifying a maintenance operation for configuring at least one of the resource and the energy consuming component for accessing the resource at a second energy cost that is less than the first energy cost. Accordingly, a system for maintaining a resource based on a cost of energy includes means for identifying a maintenance operation for configuring at least one of the resource and the energy consuming component for accessing the resource at a second energy cost that is less than the first energy cost. For example, as illustrated in FIG. 3, a maintenance link component 356 is configured for identifying a maintenance operation for configuring at least one of the resource and the energy consuming component for accessing the resource at a second energy cost that is less than the first energy cost. FIG. 4 illustrates maintenance link component 456 as an adaptation of and/or analog of maintenance link component 356 in FIG. 3. One or more maintenance link components 456 operate in execution environment 402. FIG. 5 illustrates cost maintenance subsystem (CMS) 560 including a maintenance link component (not shown) as an adaptation of and/or analog of maintenance link component 356 in FIG. 3. One or more maintenance link components operate in execution environment 502.

When a maintenance condition is met, an indication may be provided to maintenance operations component 458 identifying an energy consuming component, an accessed resource and/or a resource to be accessed, and/or one or more related components and/or resources included in accessing the resource. Maintenance operations component 458 may provide some or all of the information to maintenance link component 456 to identify a maintenance operation. Alternatively, maintenance link component 456 may include and/or determine an identifier for the maintenance operation. The identifier may identify a component for performing some or of all of the maintenance operation and/or may be a reference to a component for performing some or all of the maintenance operation.

Maintenance link component 456 may access an interface provided by an energy consuming component in order to identify the maintaining operation. Maintenance link component 456 may identify the maintenance operation based on information in the accessible resource and/or in metadata for the accessible resource. The metadata may include information received from a user allowing the user to specify a maintenance operation. A maintenance condition may be specified and/or otherwise identified based on information received from a user.

Returning to FIG. 2, block 258 illustrates that the method additionally includes in response to determining that the maintenance condition is met, sending an indication to start the maintenance operation. Accordingly, a system for maintaining a resource based on a cost of energy includes means for in response to determining that the maintenance condition is met, sending an indication to start the maintenance operation. For example, as illustrated in FIG. 3, a maintenance operations component 358 is configured for in response to determining that the maintenance condition is met, sending an indication to start the maintenance operation. FIG. 4 illustrates maintenance operations component 458 as an adaptation of and/or analog of maintenance operations component 358 in FIG. 3. FIG. 5 illustrates cost maintenance subsystem (CMS) 560 including a maintenance operations component (not shown) as an adaptation of and/or analog of maintenance operations component 358 in FIG. 3. One or more maintenance operations components operate in execution environment 502.

In various aspects, sending an indication to start a maintenance operation may include invoking an executable addressable entity via a processor memory address; sending a message via a network; sending a message via an inter-process communication mechanism including at least one of a pipe, semaphore, stack, shared data area, and queue; receiving a request such as poll and responding to invoke an operation handler, and/or scheduling starting of the maintenance operation based on at least one of a specified time and a detecting of a specified event.

In FIG. 4 maintenance link component 456 may identify a maintenance operation for energy consuming component 404 based on configuration information stored in a maintenance database 410. Maintenance database 410, in an aspect, may include a record identifying energy consuming component 404 and a maintenance operation function 412 configured to perform a maintenance operation for energy consuming component 404.

An accessed resource may be stored in a data store such as a cache and/or may be a data store such as a cache. The data store may be a hardware data store and/or the data store may be included in a data storage device such as a processor memory device and/or a secondary storage device. A maintenance condition may be based on a relative and/or absolute amount of data in the data store or a portion thereof, an average access time, a distribution of access times, a trend in access times, and/or a longest access time in a specified time period. An energy cost may be a cost per access, a cost for a group of accesses, a cost in a given time period, and/or an average, median, and/or mean cost, to name a few examples. The energy cost may be measured based on a time metric, a power metric, and/or a monetary metric as described above.

When the maintenance condition is met as determined by an adaptation and/or analog of maintenance test component 354 in FIG. 3, an adaptation and/or analog of maintenance link component 356 may identify one or more maintenance operations. Exemplary maintenance operations for an energy consuming component including a data store such as a cache may include cleaning data, flushing data, moving data, and/or copying data to and/or from at least a portion of the energy consuming component. Maintenance operations may also include restructuring at least a portion of the resource, encoding and/or otherwise translating the resource into a different representation. Additional maintenance operations further include stopping and/or starting at least a portion of the energy consuming component, adjusting power flow and/or power quality, adding and/or changing a source of energy for the energy consuming component, and/or prompting the user to perform an action such as replacing a part or taking the energy consuming component to a service center for maintenance.

Other exemplary data stores that may be accessible resources and/or that may include accessible resources accessed via an energy consuming component include a data base, a registry, and/or a file system. A data store may include a set of paths identifying locations of one or more stored resources such as code libraries and/or other executable data. Maintenance conditions may include a directory path length, a data base table size, a file name size in a file system, and a count of un-accessed entries in a registry in a specified time period, to name a few examples. Maintenance operations include changing at least a portion of a path identifier, moving a resource, changing an order of path identifiers, re-indexing one or more resources to create and/or refresh a search index, restructuring a data base table, and/or removing un-accessed data.

A resource may be a database table stored in persistent secondary storage 508 in FIG. 5 and accessed via network via network interface adapter 514. An energy cost may be detected by HD-CM 552c. HD-CM 552c may measure and/or otherwise identify an amount of electricity as electrical power utilized in accessing the table and determining an average amount of power utilized. A maintenance condition may be met when the determined average amount of power exceeds a threshold specified by the maintenance condition. Alternatively or additionally, HD-CM 552c may count and/or otherwise detect a number of spins of a disk in a disk driver and/or a distance traveled by a disk head as a metric for measuring an energy cost. A count of disk spins and/or distance moved by a disk head may be measures of energy metrics and/or used in measuring an energy cost according to a particular metric.

Alternatively or additionally, network-CM 552h may measure and/or otherwise detect one or more energy costs based on one or more specified metrics. An energy metric associated with accessing the database table and/or a resource in the database table may be based on a measure of network latency, a lease cost for a network connection, a count of bytes and/or bits communicated, a power cost for operating network interface adapter 514, and/or a cost for encoding and/or decoding data for communicating via the network, to name a few examples.

In response to detecting that a maintenance condition is met based on one or more detected energy costs, a maintenance operation such as an operation for resizing network buffers for communicating data included in an access of the database table may be identified. A communication manager (not shown) may be instructed based on the determined average energy cost to resize one or more communication buffers. The instruction may be sent by invoking an interface of the communication manager for specifying a buffer size.

The method illustrated in FIG. 2 may include additional aspects supported by various adaptations and/or analogs of the arrangement of components in FIG. 3. In various aspects a resource and/or an energy consuming component may include a data storage medium, an output component, a mechanical subcomponent, an optical subcomponent, a registry, a directory, a database, a file, an addressable entity in a program component generated from source code, a cache, a networking component, and an input component.

A metric for detecting an energy cost may be based on electrical energy, money, time, kinetic energy, chemical energy, heat, mechanical resistance, electrical resistance, magnetism, a count of an energy consuming activity, light, movement, mass metric, and/or weight.

Accessing a resource may include receiving, transmitting, storing, requesting, receiving, copying, moving, creating, modifying, deleting, translating, and/or otherwise transforming, detecting, presenting, and/or performing an operation that includes processing a resource via an energy consuming component. A cost of energy may be detected by a measuring process corresponding to an access. A cost of energy may be determined prior to, during, and/or after an access of a resource. Detecting an energy cost may include estimating at least a portion of the energy cost. For example, O-CM component 552f may determine a cost of presenting an image based on a previous presentation of the image and/or based on cost data received from a user and/or from a remote node via a network.

A maintenance condition may be evaluated and/or otherwise identified based on electrical energy, money, time, kinetic energy, chemical energy, heat, mechanical resistance, electrical resistance, magnetism, a count of an energy consuming activity, light, movement, mass metric, and/or weight. A maintenance condition may be further based on an energy cost for performing the maintenance operation. In FIG. 4, maintenance database 410 may include maintenance operation information for identifying and/or otherwise determining an energy cost for performing a maintenance operation. Maintenance test component 454 may evaluate a maintenance condition based on a measure of energy for performing a maintenance operation. For example, maintenance test component 454 may determine that a particular maintenance condition may be met when an energy cost benefit exceeds a cost of performing a particular maintenance operation. One or more maintenance test components may be configured to test maintenance conditions based on respective energy consuming components monitored directly and/or indirectly by one or more cost monitor components.

Maintenance information identifying a maintenance condition may be received from at least one of an accessible resource, an energy consuming component, a user, and a remote node via a network, to name a few sources of maintenance information. Determining that a maintenance condition is met may include a comparison based on an energy cost, a calculation based on an energy cost, and an evaluation of an expression based on an energy cost.

A maintenance operation may include defragmenting data, deleting stored data, moving data, copying data, restructuring data, translating data, flushing at least a portion of a data store, changing a size of a resource, installing a component, removing a component, updating a component, stopping a component, starting a component, setting a clock, and/or presenting a message to a user to perform an action. In an aspect, maintenance operations component 458 may send a message for presenting by a display device to present to a user to instruct the user to clean a surface, add/replace/change a part, lubricate a part, change a source of energy, change a hardware setting, modify an ambient condition such as a room temperature, and/or provide an input for a component configured to perform a maintenance operation.

As described above, a maintenance operation may be identified based on an accessed resource and/or a resource to be accessed, an energy consuming component, a type of access, a type of resource, a type of energy consuming component, an energy access cost, a user input, a message received via a network, and/or information from at least one of the resource and a component for accessing the resource.

Sending an indication to start a maintenance operation may include invoking an executable addressable entity via a processor memory address; sending a message via a network; sending a message via an inter-process communication mechanism including at least one of a pipe, semaphore, stack, shared data area, and queue; receiving a request such as a poll and responding to invoke an operation handler; and/or scheduling a start time for performing the maintenance operation.

In an aspect, a resource may include a path identifier for a location of a stored resource. The maintenance operation may include modifying the path identifier and/or changing a location of the path identifier in a plurality of path identifiers. In another aspect, an energy consuming component may be and/or may include a data storage medium. The maintenance operation may include defragmenting the resource stored in the data storage medium. In yet another aspect, a resource may be accessible via a network from a remote node. The maintenance operation may include modifying a cache for storing at least a portion of the resource. When energy costs for a storage device are low relative to energy costs for network transmission a cache may be expanded for storing accessed resources for accessing again without requiring network communication. When energy costs for a storage device are high relative to energy costs for network transmission, a cache may be made smaller and/or not used for storing accessed resources that may be accessed a second time.

An energy consuming component may be an instruction-processing unit. A maintenance operation may include modifying a processor speed, modifying a cache included in the instruction-processing, stopping the instruction processing unit, and starting the instruction processing unit.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for maintaining a resource based on a cost of energy, the method comprising:
detecting a first energy cost, measured according to a specified metric, for accessing a resource via an energy consuming component in an execution environment;
determining that a configured maintenance condition is met based on the energy cost;
identifying a maintenance operation for configuring at least one of the resource and the energy consuming component for accessing the resource at a second energy cost that is less than the first energy cost; and
in response to determining that the maintenance condition is met, sending an indication to start the maintenance operation.

2. The method of claim 1 wherein the at least one of the resource and the energy consuming component includes at least one of a data storage medium, an output component, a mechanical component, an optical component, a registry, a directory, a database, a file, an addressable entity in a program component generated from source code, a cache, a network component, and an input component.

3. The method of claim 1 wherein the metric is based on at least one of electrical energy, money, time, kinetic energy, chemical energy, heat, mechanical resistance, electrical resistance, magnetism, a count of an energy consuming operation, light, movement, mass metric, and weight.

4. The method of claim 1 wherein accessing includes at least one of receiving, transmitting, storing, requesting, copying, moving, creating, modifying, deleting, transforming, detecting, presenting, and processing a resource.

5. The method of claim 1 wherein the maintenance condition is based on at least one of electrical energy, money, time, kinetic energy, chemical energy, heat, mechanical resistance, electrical resistance, magnetism, a count of an energy consuming activity, light, movement, mass, and weight.

6. The method of claim 1 wherein the maintenance condition is based on the first energy cost for performing the maintenance operation.

7. The measure of claim 1 further comprising receiving maintenance information identifying the maintenance condition from at least one of a remote node via a network, the resource, the energy consuming component, and a user.

8. The method of claim 1 wherein determining that the maintenance condition is met includes at least one of a comparison based on the first energy cost, a calculation based on the first energy cost, and an evaluation of an expression based on the first energy cost.

9. The method of claim 1 wherein the maintenance operation includes at least one of defragmenting data, deleting stored data, moving data, copying data, restructuring data, transforming data, flushing at least a portion of a data store, changing a size of a resource, installing a component, removing a component, updating a component, stopping a component, starting a component, setting a clock, and presenting an indication message to a user to perform an action.

10. The method of claim 1 wherein the maintenance operation is identified based on at least one of the resource, the energy consuming component, a type of access, an attribute of the resource, an attribute of the energy consuming component, the first energy access cost, a user input, and a message received via a network.

11. The method of claim 1 wherein sending an indication includes at least one of invoking an executable addressable entity via a processor memory address, sending a message via a network, sending a message via an inter-process communication mechanism, receiving a request and sending the indication in response, and scheduling a start time.

12. The method of claim 1 wherein the resource is included in a data store accessed via the energy consuming component and the first energy access cost is based on an access time for accessing the resource.

13. The method of claim 12 wherein the maintenance operation includes at least one of cleaning data, flushing data, moving data, copying data at least one of to and from the energy consuming component, restructuring the resource, translating the resource into a different representation, at least one of stopping and starting the energy consuming component, adjusting an attribute of power received by the energy consuming component, at least one of adding, modifying, and removing a source of energy for the energy consuming component, modifying an access control attribute, and prompting a user to perform an action.

14. The method of claim 13 wherein the data store is at least one of included in and includes at least one of a data base, a registry, and/or a file system.

15. The method of claim 1 wherein the resource includes a path identifier for a location of a stored resource and the maintenance operation includes at least one of modifying the path identifier and changing a location of the path identifier in a plurality of path identifiers.

16. The method of claim 1 wherein the energy consuming component includes a data storage medium and the maintenance operation includes defragmenting the resource stored in the data storage medium.

17. The method of claim 1 wherein the resource is accessed via a network from a remote node and the maintenance operation includes modifying a cache for storing at least a portion of the resource.

18. The method of claim 1 wherein the energy consuming component is an instruction-processing unit and the maintenance operation includes at least one of modifying a processor speed, modifying a cache included in the instruction-processing unit, stopping the instruction-processing unit, and starting the instruction-processing unit.

19. A system for maintaining a resource based on a cost of energy, the system comprising:
a cost monitor component, a maintenance test component, a maintenance link component, and a maintenance operations component adapted for operation in an execution environment;
the cost monitor component configured for detecting a first energy cost, measured according to a specified metric, for accessing a resource via an energy consuming component in an execution environment;
the maintenance test component configured for determining that a configured maintenance condition is met based on the energy cost;
the maintenance link component configured for identifying a maintenance operation for configuring at least one of the resource and the energy consuming component for accessing the resource at a second energy cost that is less than the first energy cost; and
the maintenance operations component configured for in response to determining that the maintenance condition is met, sending an indication to start the maintenance operation.

20. A computer readable medium embodying a computer program, executable by a machine, for maintaining a resource based on a cost of energy, the computer program comprising executable instructions for:
detecting a first energy cost, measured according to a specified metric, for accessing a resource via an energy consuming component in an execution environment;
determining that a configured maintenance condition is met based on the energy cost;
identifying a maintenance operation for configuring at least one of the resource and the energy consuming component for accessing the resource at a second energy cost that is less than the first energy cost; and
in response to determining that the maintenance condition is met, sending an indication to start the maintenance operation.
